(19) United States
(12) Patent Application Publication
(10) Pub. No.: US 2010/0150553 A1
(43) Pub. Date: Jun. 17, 2010

(54) METHOD AND APPARATUS FOR GENERATING OPTICAL SHORT PULSE FOR QUANTUM CRYPTOGRAPHY COMMUNICATION

(76) Inventors: Sae-kyoung Kang, Daejeon-si (KR); Sang Soo Lee, Daejeon-si (KR); Tae-gon Noh, Daejeon-si (KR); Kwangjoon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/551,338

(22) Filed: Aug. 31, 2009

(30) Foreign Application Priority Data
Dec. 16, 2008 (KR) 10-2008-0127960

(51) Int. Cl. H04J 14/00; H04L 9/00

(52) U.S. Cl. 398/43; 380/256

(57) ABSTRACT

A method and apparatus for generating an optical short pulse for quantum cryptography communication is provided. The apparatus is incorporated as a module in an electronic integrated circuit chip, such as a field programmable gate array (FPGA) chip which performs quantum key distribution post-processing and open channel optical signal processing of a quantum cryptography system. The apparatus generates an electrical short pulse and converts the electrical short pulse into an optical short pulse, and it is possible to manufacture a compact apparatus for generating an optical short pulse for quantum cryptography communication.

### CROSS-REFERENCE TO RELATED APPLICATION

This application claims the benefit under 35 U.S.C. §119(a) of Korean Patent Application No. 10-2008-0127960, filed on Dec. 16, 2008, the disclosure of which is incorporated by reference in its entirety for all purposes.

### BACKGROUND

1. Field

The following description relates to an optical signal processing technology and, more particularly, to a method and apparatus for generating an optical short pulse for quantum cryptography communication.

2. Description of the Related Art

An optical short pulse technology has recently been a topic of growing interest for a variety of applications in optical signal processing, optical measurement, optical time-division multiplexing communication, etc.

The present invention is intended to provide a simplified method and apparatus for generating an optical short pulse for quantum cryptography communication.

### SUMMARY

The following description relates to a simplified method and apparatus for generating an optical short pulse for quantum cryptography communication.

The following description also relates to a method and apparatus for generating an optical short pulse capable of varying a repetition rate at the time when the optical short pulse is generated.

In one general aspect, an apparatus for generating an optical short pulse is incorporated as a module in an electronic integrated circuit chip, such as a field programmable gate array (FPGA) chip which performs quantum key distribution post-processing and open channel optical signal processing of a quantum cryptography system, to generate an electrical short pulse and to convert the electrical short pulse into an optical short pulse.

In another general aspect, a method and apparatus for generating an optical short pulse capable of varying a repetition rate at the time when the optical short pulse is generated.

Accordingly, it is possible to manufacture a compact apparatus for generating an optical short pulse for quantum cryptography communication and to vary a repetition rate at the time when the optical short pulse is generated.

However, other features and aspects will be apparent from the following description, the drawings, and the claims.

### BRIEF DESCRIPTION OF THE DRAWINGS

FIG. 1 is a block diagram of an apparatus for generating an optical short pulse for quantum cryptography communication according to an exemplary embodiment of the present invention.

FIG. 2 is a block diagram of an electrical short pulse generator of an apparatus for generating an optical short pulse for quantum cryptography communication according to an exemplary embodiment of the present invention.

FIG. 3 is a flow chart of a method of generating an optical short pulse for quantum cryptography communication.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

Throughout the specification, the term electrical short pulse refers to a source to generate an optical short pulse, which is pattern data arranged in series with logical values of ‘0’ and ‘1’.

The term optical short pulse is an optical signal with very short pulses into which is converted from an electrical short pulse.

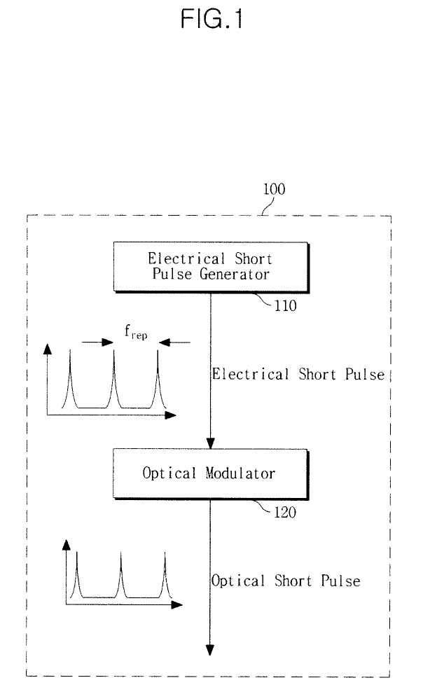

FIG. 1 is a block diagram of an apparatus for generating an optical short pulse for quantum cryptography communication according to an exemplary embodiment of the present invention.

The apparatus 100 for generating an optical short pulse is incorporated as a module in an electronic integrated circuit chip, such as a field programmable gate array (FPGA) chip which performs quantum key distribution post-processing and open channel optical signal processing of a quantum cryptography system (not shown). The apparatus 100 includes an electrical short pulse generator 110 and an optical modulator 120.

The electrical short pulse generator 110 performs clock synchronization of pattern data and multiplexes the synchronized pattern data to generate an electrical short pulse.

The optical modulator 120 converts the electrical short pulse into an optical short pulse. For example, the optical modulator 120 may be configured with laser which can be directly modulated, and may generate an optical short pulse by means of optical short pulse generation principle using a gain switching method.

Accordingly, since the apparatus 100 is incorporated as a module in an electrical integrated circuit chip, such as an FPGA chip, to generate an electrical short pulse and to convert the electrical short pulse into an optical short pulse, it is advantageous to make the apparatus 100 compact.

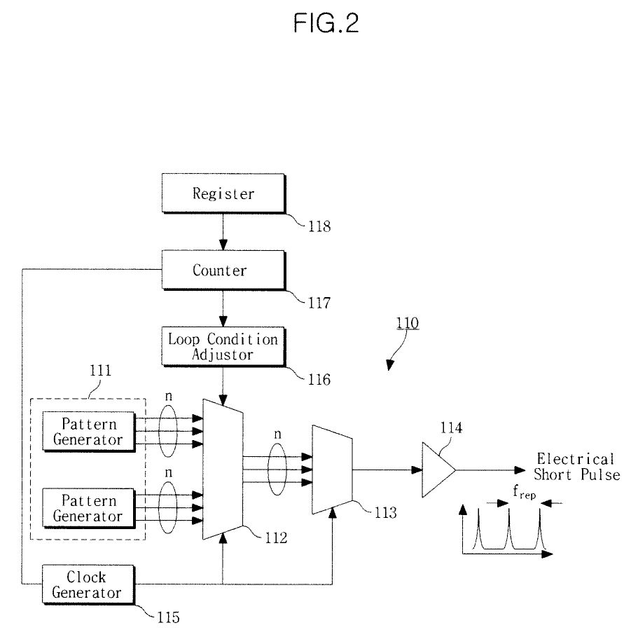

FIG. 2 is a block diagram of the electrical short pulse generator 110 according to an exemplary embodiment of the present invention.

The electrical short pulse generator 110 includes a plurality of pattern generators 111, a selector 112, and a multiplexer 113.

The pattern generator 111 generates specific pattern data. For example, as shown in FIG. 2, the pattern generators 111 may be configured to output pattern data of ‘100 . . . 000’ and ‘000 . . . 000’.

The selector 112 performs clock synchronization of selected one of a plurality of pattern data and outputs in parallel the synchronized pattern data according to a loop condition.

The loop condition may be associated with a counter value. For example, if a counter indicates a value of 0, the selector 112 may select pattern data of ‘100 . . . 000’; otherwise, it may select pattern data of ‘000 . . . 000’.

The multiplexer 113 multiplexes the pattern data synchronized and output in parallel and outputs it as an electrical short pulse. The number ‘n’ of patterns of the pattern data is determined according to a multiplexing rate. For example, in case of a multiplexing rate of 10:1, the number ‘n’ of patterns is determined to be ten (10).

The optical modulator 120 converts the electrical short pulse into an optical short pulse. Accordingly, since the apparatus 100 is incorporated as a module in an electrical integrated circuit chip to generate an electrical short pulse and to convert the electrical short pulse into an optical short pulse, it is possible to manufacture a compact apparatus for generating an optical short pulse for quantum cryptography communication.

According to another exemplary embodiment of the present invention, the electrical short pulse generator 110 may further include a drive amplifier 114. The drive amplifier 114 amplifies the electrical short pulse and outputs the amplified electrical short pulse to the optical modulator 120.

That is, the drive amplifier 114 amplifies the electrical short pulse so that the optical modulator 120 can be driven.

According to another exemplary embodiment of the present invention, the electrical short pulse generator 110 may further include a clock generator 115. The clock generator 115 generates a clock synchronized with the pattern data selected by the selector 112.

The selector 112 synchronizes the selected pattern data with the clock generated by the clock generator 115 and outputs the data.

According to another exemplary embodiment of the present invention, the electrical short pulse generator 110 may further include a loop condition adjustor 116. The loop condition adjustor 116 sets a loop condition for an output of the selector 112. The loop condition may be associated with a counter value. For example, it is assumed that first and second pattern generators 111 output data patterns of ‘100 . . . 000’ and ‘000 . . . 000’, respectively. In this case, if a counter indicates a value of 0 as a loop condition, the first pattern data is output; otherwise, the second pattern data is output.

According to another exemplary embodiment of the present invention, the electrical short pulse generator 110 may further include a counter 117. The counter 117 counts clocks from the clock generator 115. A counter value from the counter 117 may be associated with the loop condition determined by the loop condition adjustor 116.

According to another exemplary embodiment of the present invention, the electrical short pulse generator 110 may further include a register 118. The register 118 stores a count length setting value of the counter 117.

A register setting value stored in the register 118 is for varying a repetition rate at the time when an optical short pulse is generated. The register setting value is identical to the count length of the counter 117. For example, the register setting value R may be determined as the ratio of a maximum pulse generation rate, fₘₐₓ, to a desired pulse generation rate, fᵣₑₚ.

Register setting value (R)=Maximum pulse generation rate (fₘₐₓ)/Desired pulse generation rate (fᵣₑₚ)

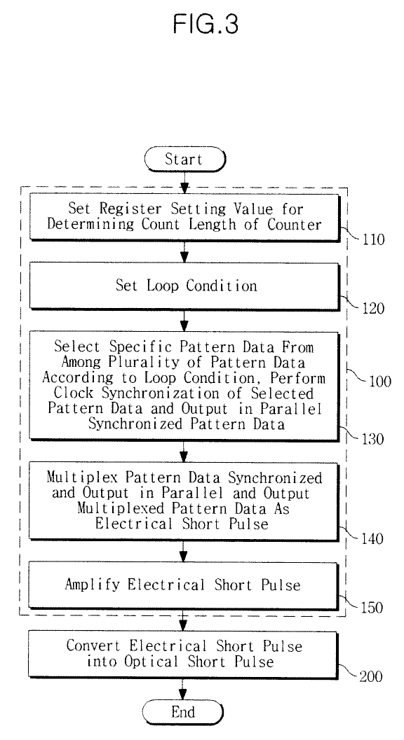

FIG. 3 is a flow chart of a method of generating an optical short pulse for quantum cryptography communication according to an exemplary embodiment of the present invention.

In operation 100, the apparatus for generating an optical short pulse for quantum cryptography communication generates an electrical short pulse. In operation 200, the apparatus converts the electrical short pulse into an optical short pulse.

Accordingly, since the apparatus for generating an optical short pulse for quantum cryptography communication is incorporated as a module in an electrical integrated circuit chip, such as an FPGA chip, to generate an electrical short pulse and to convert the electrical short pulse into an optical short pulse, it is possible to manufacture a compact apparatus for generating an optical short pulse for quantum cryptography communication.

In one embodiment, operation 100 may be divided into the following operations. In operation 110, the apparatus sets a register setting value to determine a count length of a counter. The register setting value is for varying a repetition rate at the time when the optical short pulse is generated. Since the count length of a counter depends on the register setting value, it is possible to vary the repetition rate at the time when the optical short pulse is generated.

In operation 120, the apparatus sets a loop condition. The loop condition may be associated with a clock count value of the counter. For example, one of the pattern data may be selected according to whether the clock count value is 0 or another value.

In operation 130, the apparatus selects specific pattern data from among a plurality of pattern data according to the loop condition, performs clock synchronization of the selected pattern data and outputs in parallel the synchronized pattern data.

In operation 140, the apparatus multiplexes the pattern data synchronized and output in parallel and outputs the multiplexed pattern data as an electrical short pulse.

In operation 150, the apparatus amplifies the electrical short pulse. In operation 200, the amplified electrical short pulse is converted into an optical short pulse.

Accordingly, since the apparatus for generating an optical short pulse for quantum cryptography communication is incorporated as a module in an electrical integrated circuit chip, such as an FPGA chip, to generate an electrical short pulse and to convert the electrical short pulse into an optical short pulse, it is possible to manufacture a compact apparatus for generating an optical short pulse for quantum cryptography communication. Furthermore, it is possible to vary the repetition rate at the time when the optical short pulse is generated, according to the register setting value.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating an optical short pulse for quantum cryptography communication which is incorporated as a module in an electronic integrated circuit chip including a field programmable gate array (FPGA) chip which performs quantum key distribution post-processing and open channel optical signal processing of a quantum cryptography system, the apparatus comprising:
an electrical short pulse generator to generate an electrical short pulse; and
an optical modulator to convert the electrical short pulse into an optical short pulse.

2. The apparatus of claim 1, wherein the electrical short pulse generator comprises:
a plurality of pattern generators to generate pattern data;
a selector to perform clock synchronization of selected one of the pattern data and output in parallel the synchronized pattern data according to a loop condition; and
a multiplexer to multiplex the pattern data synchronized and output in parallel and to output the multiplexed pattern data as an electrical short pulse.

3. The apparatus of claim 2, wherein the electrical short pulse generator further comprises a drive amplifier to amplify the electrical short pulse and output the amplified electrical short pulse to the optical modulator.

4. The apparatus of claim 2, wherein the electrical short pulse generator further comprises a clock generator to generate a clock synchronized with the pattern data selected by the selector.

5. The apparatus of claim 2, wherein the electrical short pulse generator further comprises a loop condition adjustor to set a loop condition for an output of the selector.

6. The apparatus of claim 5, wherein the electrical short pulse generator further comprises a counter to count clocks which are generated from the clock generator.

7. The apparatus of claim 6, wherein the loop condition is associated with a count value of the counter.

8. The apparatus of claim 6, wherein the electrical short pulse generator further comprises a register to store a register setting value for setting a count length of the counter.

9. The apparatus of claim 8, wherein the register setting value is equal to the count length of the counter.

10. A method of generating an optical short pulse for quantum cryptography communication, the method comprising:
generating an electrical short pulse; and
converting the electrical short pulse into an optical short pulse.

11. The method of claim 10, wherein the generating of the electrical short pulse comprises:
performing clock synchronization of selected one of a plurality of pattern data and outputting in parallel the synchronized pattern data according to a loop condition; and
multiplexing the pattern data synchronized and output in parallel and outputting the multiplexed pattern data as an electrical short pulse.

12. The method of claim 11, wherein the generating of the electrical short pulse further comprises amplifying the electrical short pulse.

13. The method of claim 11, wherein the generating of the electrical short pulse further comprises setting the loop condition.

14. The method of claim 13, wherein the loop condition is associated with an output value of a counter which counts clocks.

15. The method of claim 14, wherein the generating of the electrical short pulse further comprises setting a register setting value for determining a count length of the counter.
